(19) United States
(12) Patent Application Publication
(10) Pub. No.: US 2024/0320702 A1
(43) Pub. Date: Sep. 26, 2024

(54) INFORMATION PROVIDING METHOD AND INFORMATION PROVIDING SYSTEM

(71) Applicant: Panasonic Automotive Systems Co., Ltd., Kanagawa (JP)

(72) Inventors: Akihiko IGUCHI, Osaka Fu (JP); Fumio KOSUGE, Kanagawa Ken (JP); Shinya AIZAWA, Kanagawa Ken (JP)

(73) Assignee: Panasonic Automotive Systems Co., Ltd., Kanagawa (JP)

(21) Appl. No.: 18/737,519

(22) Filed: Jun. 7, 2024

Related U.S. Application Data
(63) Continuation of application No. PCT/JP2022/029839, filed on Aug. 3, 2022.

(30) Foreign Application Priority Data
Dec. 16, 2021 (JP) 2021-204665

(51) Int. Cl. G06Q 30/0207; G01C 21/36; G06V 20/52; G06V 20/62

(52) U.S. Cl. CPC G06Q 30/0224; G01C 21/3682; G01C 21/3697; G06Q 30/0236; G06V 20/52; G06V 20/625; G06V 2201/08

(57) ABSTRACT

An information providing method includes: acquiring, from a first server, a point ID corresponding to a user who is on a vehicle parked in a parking lot and parking position distance information indicating a distance from a parking position to an entrance connecting the parking lot and a commercial facility; and when the distance from the parking position to the entrance is equal to or larger than a predetermined value based on purchase information and the parking position distance information of the user corresponding to the point ID, transmitting, to the first server, first coupon information representing a coupon available in at least one store among a plurality of stores where a use frequency by the user is equal to or larger than a certain value in order to display the first coupon information on an information terminal of the user corresponding to the point ID.

### CROSS-REFERENCE TO RELATED APPLICATIONS

This application is a continuation of International Application No. PCT/JP2022/029839, filed on Aug. 3, 2022 which claims the benefit of priority of the prior Japanese Patent Application No. 2021-204665, filed on Dec. 16, 2021, the entire contents of which are incorporated herein by reference.

### FIELD

The present disclosure relates to an information providing method and an information providing system.

### BACKGROUND

JP 2006-107147 A discloses a technique of making notification of store information after a vehicle is parked in a parking lot in a commercial facility or the like by using information such as a parking position wish of a user, an interest field, a use store, and the like registered in advance.

According to the technique of JP 2006-107147 A, there is room for further improvement in the content of the recommendation to the user. For example, in a case where the parking position is far from the entrance of the store, it is not possible to notify the user of a coupon or the like serving as an incentive.

The present disclosure has an object to provide an information providing method and an information providing system that can give an incentive according to a parking position to a user.

### SUMMARY

An information providing method according to the present disclosure is in a sales information management system including a second server that communicates with a parking management system including a first server related to a parking lot and stores purchase information of a user in a commercial facility in association with a point ID of the user in connection with the commercial facility. The information providing method includes: acquiring, from the first server, the point ID corresponding to the user who is on a vehicle parked in the parking lot and parking position distance information indicating a distance from a parking position where the vehicle is parked in the parking lot to an entrance connecting the parking lot and the commercial facility, wherein a vehicle number indicating the vehicle and the parking position distance information are determined using a vehicle image indicating the vehicle acquired by a camera installed in the parking lot, and the corresponding point ID is determined based on the vehicle number, in the parking management system; and when the distance from the parking position to the entrance connecting the commercial facility and the parking lot is equal to or larger than a predetermined value based on the purchase information and the parking position distance information of the user corresponding to the point ID, transmitting, to the first server, first coupon information representing a coupon available in at least one store among a plurality of stores where a use frequency by the user is equal to or larger than a certain value in order to display the first coupon information on an information terminal of the user corresponding to the point ID.

### BRIEF DESCRIPTION OF THE DRAWINGS

FIG. 1 is a diagram illustrating an example of a configuration of a parking information-linked recommendation system according to an embodiment;

FIG. 2 is a hardware block diagram illustrating an example of a hardware configuration of an infrastructure server and a store server included in the parking information-linked recommendation system according to the embodiment;

FIG. 3 is a functional block diagram illustrating an example of functional configurations of the infrastructure server and the store server included in the parking information-linked recommendation system according to the embodiment;

FIG. 4 is a hardware block diagram illustrating an example of a hardware configuration of an operation terminal included in the parking information-linked recommendation system according to the embodiment;

FIG. 5 is a functional block diagram illustrating an example of a functional configuration of the operation terminal included in the parking information-linked recommendation system according to the embodiment;

FIG. 6 is a sequence diagram illustrating an example of a procedure of user information registration processing executed by the parking information-linked recommendation system according to the embodiment;

FIG. 7 is a sequence diagram illustrating an example of a procedure of coupon information presentation processing executed by the parking information-linked recommendation system according to the embodiment;

FIG. 8 is a diagram illustrating an example of a configuration of user data stored in the infrastructure server according to the embodiment;

FIG. 9 is a diagram illustrating an example of a configuration of parking data stored in the infrastructure server according to the embodiment;

FIG. 10 is a diagram illustrating an example of a configuration of map data stored in the infrastructure server according to the embodiment;

FIG. 11 is a diagram illustrating an example of a configuration of user data stored in the store server according to the embodiment;

FIG. 12 is a diagram illustrating an example of a configuration of point data stored in the store server according to the embodiment;

FIG. 13 is a diagram illustrating an example of a configuration of POS data stored in the store server according to the embodiment;

FIG. 14 is a diagram illustrating an example of a configuration of similar store data stored in the store server according to the embodiment;

FIG. 15 is a flowchart illustrating an example of a flow of processing executed by the parking information-linked recommendation system according to the embodiment;

FIG. 16 is a diagram illustrating an example of a main menu screen displayed on the operation terminal;

FIG. 17 is a diagram illustrating an example of a user registration screen displayed on the operation terminal;

FIG. 18 is a diagram illustrating an example of a screen displayed when the input user data is registered in the infrastructure server;

FIG. 19 is a diagram illustrating an example of a feedback screen indicating that the user data has been registered;

FIG. 20 is a diagram illustrating an example of a coupon information notification screen displayed on the operation terminal;

FIG. 21 is a diagram illustrating an example of a coupon information summary display screen displayed on the operation terminal;

FIG. 22 is a diagram illustrating an example of a coupon information detail display screen displayed on the operation terminal; and

FIG. 23 is a diagram illustrating an example of a route display screen displayed on the operation terminal.

### DETAILED DESCRIPTION

Hereinafter, embodiments of a parking information-linked recommendation system according to the present disclosure will be described with reference to the drawings.

### Schematic Configuration of Parking Information-Linked Recommendation System

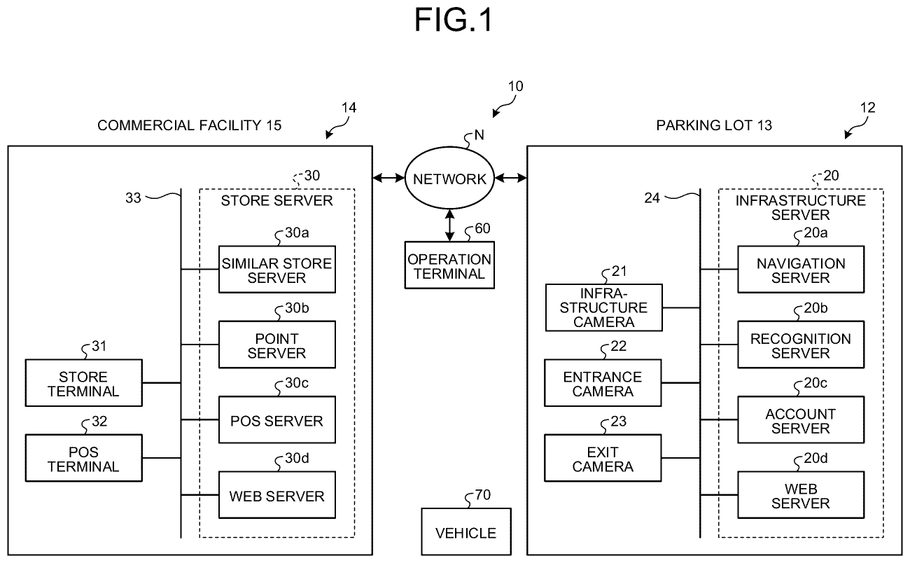

A schematic configuration of a parking information-linked recommendation system 10 will be described with reference to FIG. 1. FIG. 1 is a diagram illustrating an example of a configuration of a parking information-linked recommendation system according to the embodiment.

The parking information-linked recommendation system 10 is installed in a parking lot 13 and a commercial facility 15. The parking information-linked recommendation system 10 communicates with an operation terminal 60 possessed by a user, the parking lot 13, and the commercial facility 15 via a network N. The parking lot 13 is adjacent to the commercial facility 15, and the user parks a vehicle 70 in the parking lot 13 and shops at the commercial facility 15. Note that the network N is a mobile phone network having a large number of base stations as terminals, a satellite communication network using communication satellites, or the like.

The parking information-linked recommendation system 10 gives an incentive such as presenting coupon information to a user who visits the parking lot 13 of the commercial facility 15 according to a distance from a parking position of the vehicle 70 to an entrance connecting the parking lot 13 and the commercial facility 15 based on user information and vehicle information associated with the user information that are registered in advance by the user using the operation terminal 60. Note that the parking information-linked recommendation system is an example of an information providing system in the present disclosure.

Note that the vehicle associated with the user information is, for example, a vehicle owned by the user, but is not limited thereto. For example, the user may register a vehicle on which the user rides, such as a vehicle of a family member or a friend, or may register a vehicle that is temporarily or intermittently used by using a rental car, car sharing, or the like.

The parking lot 13 includes a parking management system 12 in which an infrastructure server 20, an infrastructure camera 21, an entrance camera 22, and an exit camera 23 are connected by a LAN 24.

The infrastructure server 20 performs various processes related to management of the parking lot. The infrastructure server 20 includes a navigation server 20a, a recognition server 20b, an account server 20c, and a WEB server 20d. Note that the infrastructure server 20 is an example of a first server in the present disclosure.

The navigation server 20a acquires position information and map information related to the parking lot 13, and searches for an entrance that connects the parking lot 13 and the commercial facility 15 closest to the parking position of the vehicle 70. In addition, the navigation server 20a provides the search result to the operation terminal 60 of the user via the network N.

The recognition server 20b recognizes the parked vehicle position and the full/vacant information of the parking lot 13 and updates the information as needed. More specifically, the recognition server 20b recognizes a license plate number, a vehicle model, and a vehicle body color of the vehicle 70 that has entered the parking lot 13 based on an image (vehicle image) captured by the entrance camera 22. In addition, the recognition server 20b extracts features (the license plate number, vehicle model, vehicle body color) indicating the vehicle 70 from the images captured by the plurality of infrastructure cameras 21, and tracks the vehicle 70 based on the features, thereby recognizing the current position and the vehicle state of the vehicle 70. In addition, the recognition server 20b acquires the state of the parking lot 13, for example, full/vacant information, based on the images captured by the plurality of infrastructure cameras 21.

The account server 20c manages the vehicle information and the user information in association with each other.

The WEB server 20d accesses the network N and manages information such as a display to be transmitted to the operation terminal 60.

Note that, here, it has been described that the infrastructure server 20 includes a plurality of server devices, but all or a part of the plurality of server devices may be aggregated into one server device.

A plurality of the infrastructure cameras 21 is installed on the ceiling or the like of the parking lot 13 so as to be able to monitor the inside of the parking lot 13 without omission, and captures images of the inside of the parking lot 13 as needed. The infrastructure camera 21 transmits the captured image to the infrastructure server 20. The infrastructure server 20 analyzes the images captured in time series by the plurality of infrastructure cameras 21, and specifies the current position of the vehicle 70 using the license plate number, the vehicle model, and the vehicle body color recognized from the image captured by the entrance camera 22 when the vehicle enters the parking lot 13 as clues.

The entrance camera 22 is installed at an entrance gate of the parking lot 13, and captures an image including a license plate of the vehicle 70 entering the parking lot 13. The entrance camera 22 transmits the captured image to the infrastructure server 20. The infrastructure server 20 recognizes the license plate number, the vehicle model, and the vehicle body color of the vehicle 70 by analyzing the image captured by the entrance camera 22. In addition, the infrastructure server 20 recognizes the occupant of the vehicle 70 by analyzing the image captured by the entrance camera 22.

The exit camera 23 is installed at an exit gate of the parking lot 13 and captures an image including the license plate of the vehicle 70 exiting from the parking lot 13. The exit camera 23 transmits the captured image to the infrastructure server 20.

The commercial facility 15 includes a sales information management system 14 in which a store server 30, a store terminal 31, and a POS terminal 32 are connected by a LAN 33.

The store server 30 performs various processes related to sales management in the commercial facility 15. The store server 30 includes a similar store server 30a, a point server 30b, a POS server 30c, and a WEB server 30d. Note that the store server 30 is an example of a second server in the present disclosure.

The similar store server 30a determines and manages similarity of stores in the commercial facility 15.

The point server 30b manages user information and performs point granting management. In addition, the point server 30b generates coupon information to be transmitted to the user. Coupon information (an example of first coupon information in the present disclosure) is discount information of a product that is generated based on purchase information of a user and is available in at least one store among stores where a use frequency by the user is equal to or larger than a certain value. In addition, the point server 30b may generate coupon information (an example of second coupon information in the present disclosure) that can be used in a second store different from the one store among the plurality of stores where the use frequency by the user is equal to or larger than a certain value, together with the coupon information.

The POS server 30c manages sales data.

The WEB server 30d accesses the network N and manages information such as a display to be transmitted to the operation terminal 60.

Note that, here, it has been described that the store server 30 includes a plurality of server devices, but all or a part of the plurality of server devices may be aggregated into one server device.

The operation terminal 60 is a portable terminal carried by the user, and is, for example, a smartphone, a tablet terminal, or the like. The operation terminal 60 functions as an information input terminal when the user information and the vehicle information are registered. In addition, the operation terminal 60 functions as a display terminal that displays a map from the parking position of the vehicle 70 to the entrance connecting the parking lot 13 and the commercial facility 15, coupon information, and the like transmitted from the infrastructure server 20 in a browsable manner. Note that the operation terminal 60 is an example of an information terminal in the present disclosure.

### Hardware Configuration of Server Device

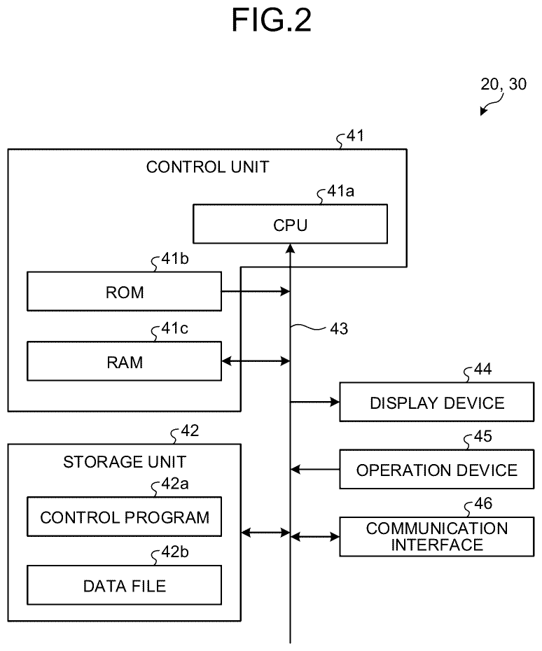

The hardware configurations of the infrastructure server 20 and the store server 30 included in the parking information-linked recommendation system 10 will be described with reference to FIG. 2. FIG. 2 is a hardware block diagram illustrating an example of a hardware configuration of an infrastructure server and a store server included in the parking information-linked recommendation system according to the embodiment.

The infrastructure server 20 and the store server 30 have the same hardware configuration. That is, the infrastructure server 20 and the store server 30 have a configuration in which a control unit 41, a storage unit 42, a display device 44, an operation device 45, and a communication interface 46 are connected to each other by an internal bus 43.

Note that the navigation server 20a, the recognition server 20b, the account server 20c, and the WEB server 20d constituting the infrastructure server 20, and the similar store server 30a, the point server 30b, the POS server 30c, and the WEB server 30d constituting the store server 30 all have the hardware configuration illustrated in FIG. 2. That is, the hardware configuration illustrated in FIG. 2 may be regarded as a hardware configuration of the navigation server 20a, the recognition server 20b, the account server 20c, and the WEB server 20d constituting the infrastructure server 20. Furthermore, the hardware configuration illustrated in FIG. 2 may be regarded as a hardware configuration of the similar store server 30a, the point server 30b, the POS server 30c, and the WEB server 30d constituting the store server 30.

The control unit 41 executes various controls related to the infrastructure server 20 and the store server 30. The control unit 41 includes a central processing unit (CPU) 41a, a read only memory (ROM) 41b, and a random access memory (RAM) 41c. The CPU 41a is connected to the ROM 41b and the RAM 41c via the internal bus 43.

The CPU 41a loads various programs stored in the ROM 41b and the storage unit 42 in the RAM 41c. The CPU 41a controls the operations of the infrastructure server 20 and the store server 30 by operating according to the various programs loaded in the RAM 41c. That is, the control unit 41 has a general computer configuration.

The storage unit 42 is a storage device such as a hard disk drive (HDD) or a solid state drive (SSD). Furthermore, the storage unit 42 may be a nonvolatile memory such as a flash memory in which stored information is stored even when the power is turned off. The storage unit 42 stores a control program 42a and a data file 42b.

The control program 42a is a program that controls the entire operation of the infrastructure server 20 and the store server 30.

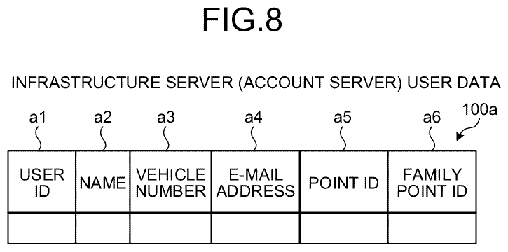

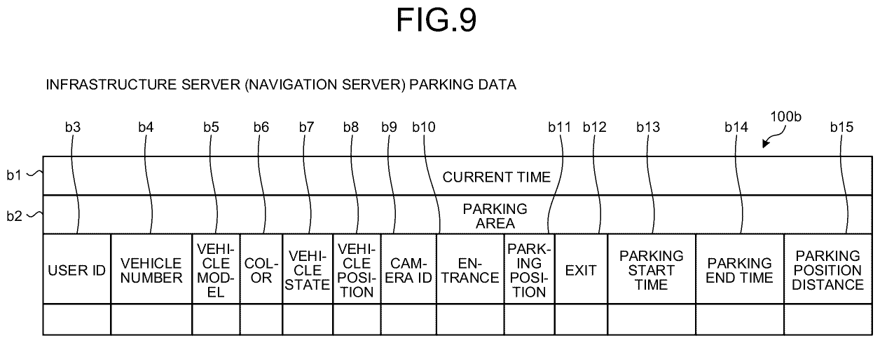

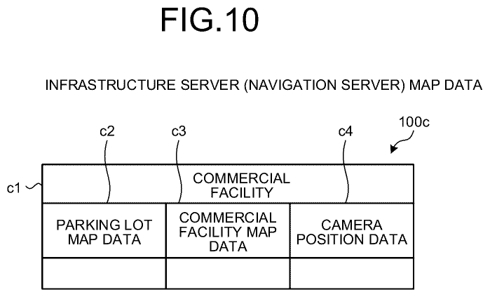

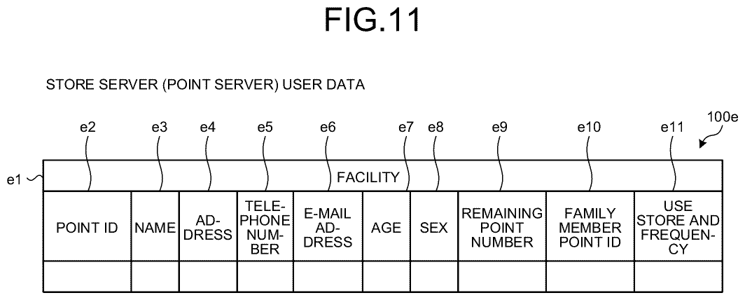

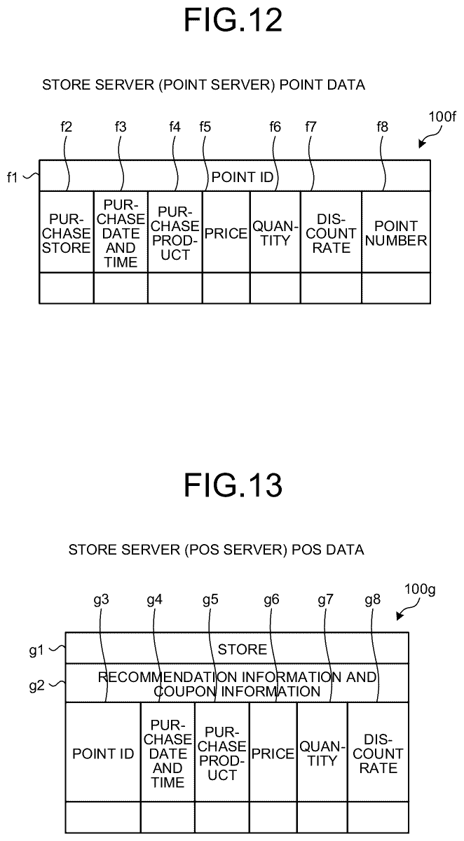

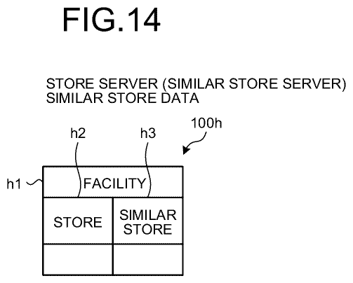

The data file 42b is a file storing various types of information acquired or generated by the infrastructure server 20 and the store server 30. Specifically, the infrastructure server 20 (account server 20c) stores user data 100a (see FIG. 8) in the data file 42b. In addition, the infrastructure server 20 (navigation server 20a) stores parking data 100b (see FIG. 9) and map data 100c (see FIG. 10) in the data file 42b. In addition, the store server 30 (point server 30b) stores user data 100e (see FIG. 11) and point data 100f (see FIG. 12) in the data file 42b. Further, the store server 30 (POS server 30c) stores POS data 100g (see FIG. 13) in the data file 42b. In addition, the store server 30 (similar store server 30a) stores similar store data 100h (see FIG. 14) in the data file 42b.

The display device 44 displays a screen generated by an instruction from the control unit 41. The display device 44 is configured of, for example, a device such as a liquid crystal display (LCD) or an organic electro-luminescence (EL).

The operation device 45 acquires an input operation of an operator and transmits the input operation to the control unit 41. The operation device 45 is configured of, for example, a device such as a keyboard or a touch panel.

The communication interface 46 is an interface for performing communication between the infrastructure server 20 and the store server 30 via the network N. Furthermore, the communication interface 46 is an interface for performing communication between the infrastructure server 20 and the operation terminal 60 via a known communication line such as the network N or a mobile phone network.

### Functional Configuration of Server Device

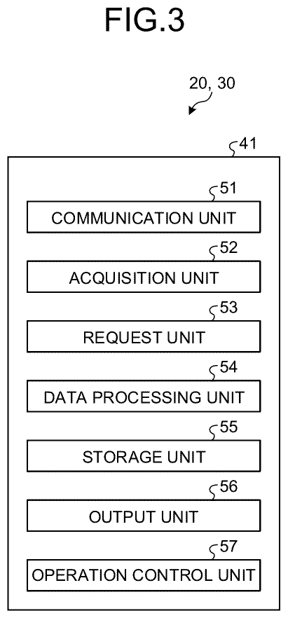

The functional configurations of the infrastructure server 20 and the store server 30 included in the parking information-linked recommendation system 10 will be described with reference to FIG. 3. FIG. 3 is a functional block diagram illustrating an example of functional configurations of an infrastructure server and a store server included in the parking information-linked recommendation system according to the embodiment.

Note that the navigation server 20a, the recognition server 20b, the account server 20c, and the WEB server 20d constituting the infrastructure server 20, and the similar store server 30a, the point server 30b, the POS server 30c, and the WEB server 30d constituting the store server 30 all have the functional configurations illustrated in FIG. 3.

The control unit 41 of the infrastructure server 20 and the store server 30 loads the control program 42a in the RAM 41c and operates the same, thereby implementing a communication unit 51, an acquisition unit 52, a request unit 53, a data processing unit 54, a storage unit 55, an output unit 56, and an operation control unit 57 illustrated in FIG. 3 as functional units.

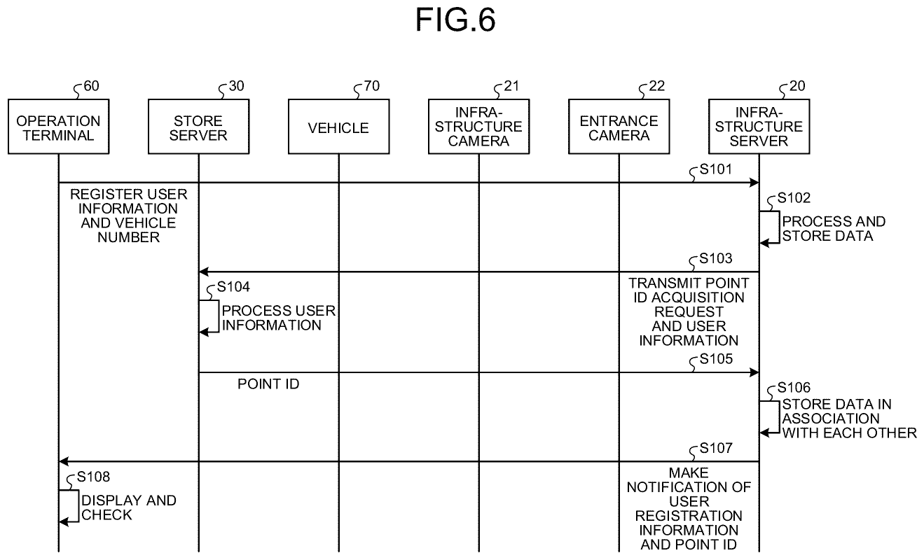

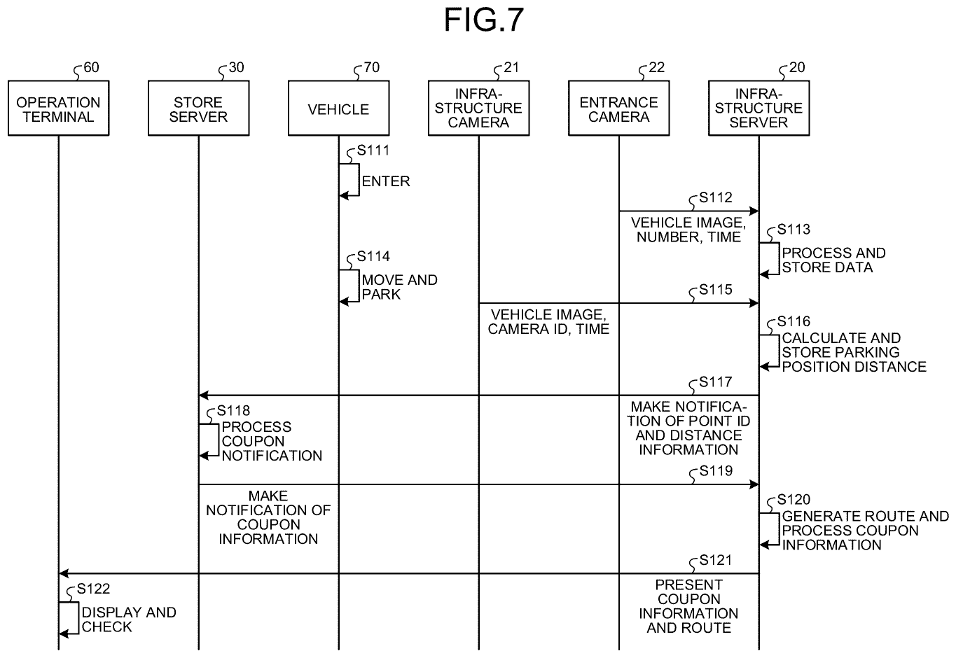

The communication unit 51 transmits and receives information between the infrastructure server 20 and the store server 30, or between the operation terminal 60 and the infrastructure server 20. The communication unit 51 transmits and receives information via a known communication line such as the network N or a mobile phone network. Specific information to be transmitted and received will be described with reference to a sequence diagram described later (See FIGS. 6 and 7).

The acquisition unit 52 acquires various types of information received by the communication unit 51.

The request unit 53 makes a processing request to the other server between the infrastructure server 20 and the store server 30 based on the processing result of the data processing unit 54 or the like.

The data processing unit 54 performs predetermined data processing based on the information acquired by the acquisition unit 52.

The storage unit 55 stores various types of information acquired by the acquisition unit 52, the processing result of the data processing unit 54, and the like.

The output unit 56 passes and transmits information that needs to be output to the outside to the communication unit 51.

The operation control unit 57 controls the operations of the infrastructure server 20 and the store server 30 by operating the control program 42a.

### Hardware Configuration of Operation Terminal

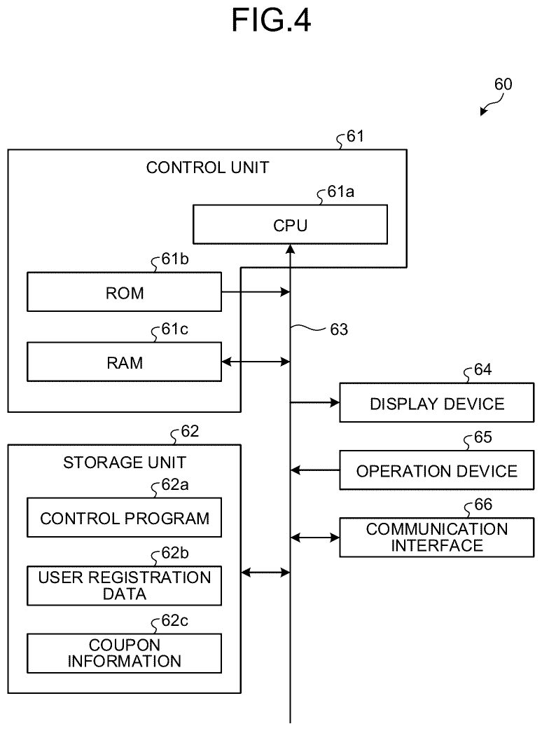

A hardware configuration of the operation terminal 60 will be described with reference to FIG. 4. FIG. 4 is a hardware block diagram illustrating an example of a hardware configuration of an operation terminal included in the parking information-linked recommendation system according to the embodiment.

The operation terminal 60 has a configuration in which a control unit 61, a storage unit 62, a display device 64, an operation device 65, and a communication interface 66 are connected to each other by an internal bus 63.

The control unit 61 executes various controls related to the operation terminal 60. The control unit 61 includes a CPU 61a, a ROM 61b, and a RAM 61c. The CPU 61a is connected to the ROM 61b and the RAM 61c via the internal bus 63.

The CPU 61a loads various programs stored in the ROM 61b and the storage unit 62 in the RAM 61c. The CPU 61a controls the operation of the operation terminal 60 by operating according to the various programs loaded in the RAM 61c. That is, the control unit 61 has a general computer configuration.

The storage unit 62 is a storage device such as an HDD or an SSD. Furthermore, the storage unit 62 may be a nonvolatile memory such as a flash memory in which stored information is stored even when the power is turned off. The storage unit 62 stores a control program 62a, user registration data 62b, and coupon information 62c.

The control program 62a is a program that controls the entire operation of the operation terminal 60.

The user registration data 62b is a data file storing various kinds of attribute information input by the user.

The coupon information 62c is coupon information notified from the infrastructure server 20.

The display device 64 displays a screen generated by an instruction from the control unit 61. The display device 64 is configured of, for example, a device such as an LCD or an organic EL.

The operation device 65 acquires an input operation of the operator and transmits the input operation to the control unit 61. The operation device 65 is configured of, for example, a device such as a keyboard or a touch panel.

The communication interface 66 is an interface for performing communication with the infrastructure server 20 via a known communication line such as the network N or a mobile phone network.

### Functional Configuration of Operation Terminal

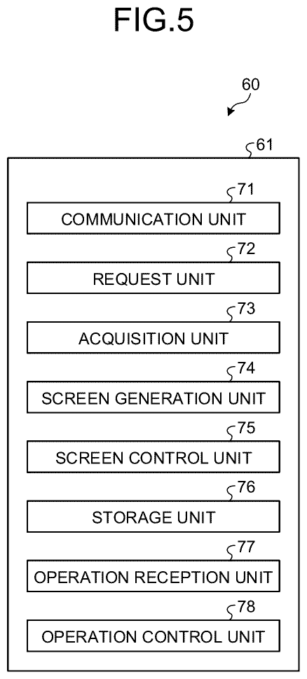

A functional configuration of the operation terminal 60 will be described with reference to FIG. 5. FIG. 5 is a functional block diagram illustrating an example of a functional configuration of an operation terminal included in the parking information-linked recommendation system according to the embodiment.

The control unit 61 of the operation terminal 60 loads the control program 62a in the RAM 61c and operates the same, thereby implementing a communication unit 71, a request unit 72, an acquisition unit 73, a screen generation unit 74, a screen control unit 75, a storage unit 76, an operation reception unit 77, and an operation control unit 78 illustrated in FIG. 5 as functional units.

The communication unit 71 transmits and receives information between the operation terminal 60 and the infrastructure server 20. For example, the communication unit 71 transmits the user information, the vehicle information, and the like input to the operation terminal 60 to the infrastructure server 20 via a known communication line such as the network N or a mobile phone network. Furthermore, the communication unit 71 receives, from the infrastructure server 20, user registration information, coupon information, map information from the parking position of the vehicle 70 to an entrance connecting the parking lot 13 and the commercial facility 15, and the like.

The request unit 72 makes a processing request to the infrastructure server 20 according to the operation information acquired by the operation reception unit 77.

The acquisition unit 73 acquires information received by the communication unit 71 from the infrastructure server 20.

The screen generation unit 74 generates screen information to be displayed on the display device 64 of the operation terminal 60.

The screen control unit 75 causes the display device 64 of the operation terminal 60 to display the screen information generated by the screen generation unit 74.

The storage unit 76 stores the various types of information acquired by the acquisition unit 73 in the storage unit 62 of the operation terminal 60.

The operation reception unit 77 acquires input information to the operation device 65 of the operation terminal 60 to receive an operation instruction and an information input from the user.

The operation control unit 78 controls the operation of the operation terminal 60 by operating the control program 62a based on the information acquired by the operation terminal 60.

### Flow of User Information Registration Processing

A flow of user information registration processing performed by the parking information-linked recommendation system 10 will be described with reference to FIG. 6. FIG. 6 is a sequence diagram illustrating an example of a procedure of user information registration processing executed by the parking information-linked recommendation system according to the embodiment. Note that, in FIG. 6, the description of a portion where data is transmitted and received between different servers inside the infrastructure server 20 or inside the store server 30 is omitted.

The communication unit 71 of the operation terminal 60 transmits the user information input by the user and the vehicle information such as the vehicle number to the infrastructure server 20 (account server 20c) (step S101).

The data processing unit 54 of the infrastructure server 20 (account server 20c) converts the acquired user information and vehicle information such as a vehicle number into a predetermined format. Then, the storage unit 55 stores the user information and the vehicle information converted into the predetermined format in the data file 42b (step S102).

The request unit 53 of the infrastructure server 20 (WEB server 20d) transmits the user information to the store server 30 (WEB server 30d) to request acquisition of the point ID (step S103).

The data processing unit 54 of the store server 30 (point server 30b) performs user information processing of reading the point ID associated with the user information based on the user information acquired in step S103 (step S104).

The output unit 56 of the store server 30 (WEB server 30d) causes the communication unit 51 to transmit the read point ID to the infrastructure server 20 (WEB server 20d) (step S105).

The acquisition unit 52 of the infrastructure server 20 (account server 20c) acquires the point ID received by the communication unit 51. Then, the storage unit 55 stores the user information and the point ID in association with each other (step S106).

The output unit 56 of the infrastructure server 20 (WEB server 20d) causes the communication unit 51 to transmit the registration information (the user information and the vehicle information) registered in step S102 and the point ID to the operation terminal 60 (step S107).

The acquisition unit 73 of the operation terminal 60 acquires the user information, the vehicle information, and the point ID. Then, the screen generation unit 74 of the operation terminal 60 generates screen information for displaying the acquired information on the display device 64 of the operation terminal 60. In addition, the screen control unit 75 of the operation terminal 60 displays the screen information generated by the screen generation unit 74 on the display device 64 of the operation terminal 60 (step S108). The user checks the user information, the vehicle information, and the point ID by browsing the screen displayed on the display device 64.

### Flow of Coupon Information Presentation Processing

A flow of coupon information presentation processing performed by the parking information-linked recommendation system 10 will be described with reference to FIG. 7. FIG. 7 is a sequence diagram illustrating an example of a procedure of coupon information presentation processing executed by the parking information-linked recommendation system according to the embodiment. Note that, in FIG. 7, the description of a portion where data is transmitted and received between different servers inside the infrastructure server 20 or inside the store server 30 is omitted.

The vehicle 70 enters the parking lot 13 (step S111).

The entrance camera 22 captures an image including the license plate of the vehicle 70, and transmits the image to the infrastructure server 20 (WEB server 20d) together with the captured time (step S112).

The acquisition unit 52 of the infrastructure server 20 (recognition server 20b) acquires the image including the license plate of the vehicle 70 and the time when the image was captured, which are transmitted in step S112. Then, the data processing unit 54 of the infrastructure server 20 (recognition server 20b) acquires or generates data corresponding to a corresponding place of the parking data 100b (see FIG. 9) to be described later, that is, the user ID, the vehicle number, the vehicle model, the color, the vehicle state, the vehicle position, the camera ID, the entrance, and the parking start time illustrated in FIG. 9 to be described later, and stores the data as the parking data 100b (step S113).

The vehicle 70 that has entered the parking lot 13 travels in the parking lot 13 and is parked in a place where parking is possible (step S114).

The infrastructure camera 21 transmits an image in the parking lot 13 imaged as needed and the time of imaging to the infrastructure server 20 (WEB server 20d) (step S115).

The acquisition unit 52 of the infrastructure server 20 (recognition server 20b) acquires the image in the parking lot 13 and the captured time which are transmitted in step S115. Then, the data processing unit 54 of the infrastructure server 20 (recognition server 20b) recognizes the vehicle 70 from the acquired images, and specifies that the vehicle 70 has completed parking and its parking position. In addition, the data processing unit 54 of the infrastructure server 20 (navigation server 20a) calculates parking position distance information from the parking position of the vehicle 70 to the closest entrance connecting the parking lot 13 and the commercial facility 15. Then, the storage unit 55 of the infrastructure server 20 (navigation server 20a) stores the parking position of the vehicle 70 and the parking position distance information (step S116).

The output unit 56 of the infrastructure server 20 (WEB server 20d) causes the communication unit 51 to transmit the point ID associated with the user of the vehicle 70 and the distance from the parking position of the vehicle 70 to the closest entrance connecting the parking lot 13 and the commercial facility 15 to the store server 30 (WEB server 30d) (step S117). Note that the user of the vehicle 70 may be a driver of the vehicle 70, or a fellow passenger of the vehicle 70 managed as a family member or a friend of the driver of the vehicle 70. Whether the user, or a family member or a friend of the user is on the vehicle 70 can be recognized based on, for example, whether an occupant matching a face image registered in advance is detected from images captured by the entrance camera 22 and the infrastructure camera 21. Furthermore, in a case where the vehicle 70 is equipped with an on-vehicle device having a communication function with the infrastructure server 20, the infrastructure server 20 may receive, from the on-vehicle device of the vehicle 70, that there is a user registered in the user data 100a (see FIG. 10) among the occupants in the vehicle 70, and the user ID of the user.

The acquisition unit 52 of the store server 30 (point server 30b) acquires the point ID associated with the user of the vehicle 70 and the distance from the parking position of the vehicle 70 to the entrance connecting the parking lot 13 and the commercial facility 15, which are transmitted in step S117. Then, in a case where the distance from the parking position of the vehicle 70 to the entrance connecting the parking lot 13 and the commercial facility 15 is equal to or larger than a predetermined value, the data processing unit 54 of the store server 30 (point server 30b) performs coupon notification processing of generating coupon information (first coupon information) that can be used in at least one store among stores where the use frequency based on the purchase information of the user of the vehicle 70 is equal to or larger than a certain value (step S118). At this time, the store server 30 (point server 30b) may generate the second coupon information described above together with the first coupon information.

The output unit 56 of the store server 30 (WEB server 30d) causes the communication unit 51 to transmit the coupon information (first coupon information, or first coupon information and second coupon information) generated in step S118 to the infrastructure server 20 (WEB server 20d) (step S119).

The acquisition unit 52 of the infrastructure server 20 (account server 20c) acquires the coupon information (first coupon information, or first coupon information and second coupon information) transmitted in step S119. In addition, the data processing unit 54 of the infrastructure server 20 (navigation server 20a) creates a map from the parking position of the vehicle 70 to the entrance that connects the parking lot 13 and the commercial facility 15. Further, the data processing unit 54 of the infrastructure server 20 (account server 20c) performs coupon information processing for converting the acquired coupon information into a format to be transmitted to the user of the vehicle 70 (step S120).

The output unit 56 of the infrastructure server 20 (WEB server 20d) causes the communication unit 51 to transmit the coupon information (first coupon information, or first coupon information and second coupon information) and the map from the parking position of the vehicle 70 to the closest entrance connecting the parking lot 13 and the commercial facility 15 to the operation terminal 60 possessed by the user of the vehicle 70 (step S121).

The acquisition unit 73 of the operation terminal 60 acquires the coupon information (first coupon information, or first coupon information and second coupon information) and the map from the parking position of the vehicle 70 to the closest entrance connecting the parking lot 13 and the commercial facility 15. The screen generation unit 74 of the operation terminal 60 generates screen information for displaying the acquired information on the display device 64 of the operation terminal 60. In addition, the screen control unit 75 of the operation terminal 60 displays the screen information generated by the screen generation unit 74 on the display device 64 of the operation terminal 60 (step S122). The user checks the coupon information and the map from the parking position of the vehicle 70 to the entrance connecting the parking lot 13 and the commercial facility 15 by browsing the screen displayed on the display device 64.

Note that, in a case where the user uses the first coupon or the second coupon in the store, the store server 30 (POS server 30c) detects that the coupon information has been used. Then, when the user uses the first coupon information, the sales information management system 14 invalidates the second coupon information. Also, when the user uses the second coupon information, the sales information management system 14 invalidates the first coupon information.

### Configuration of User Data

The configuration of the user data 100a stored in the infrastructure server 20 (account server 20c) will be described with reference to FIG. 8. FIG. 8 is a diagram illustrating an example of a configuration of user data stored in the infrastructure server according to the embodiment.

The user data 100a includes a user ID a1, a name a2, a vehicle number a3, an e-mail address a4, a point ID a5, and a family point ID a6. That is, the user ID, point ID, and vehicle number of the user are stored in association with each other.

The user ID a1 is identification information that is managed by the infrastructure server 20 and uniquely specifies a user who uses the parking lot 13.

The name a2 is the name of the user corresponding to the user ID a1.

The vehicle number a3 is information described on the license plate of the vehicle 70.

The e-mail address a4 is an e-mail address of the operation terminal 60 possessed by the user corresponding to the user ID a1.

The point ID a5 is identification information that is managed by the store server 30 and uniquely specifies the user. Note that the user ID a1 and the point ID a5 point to the same user managed by different servers.

The family point ID a6 is a point ID of a user associated with the user registered in the user ID a1, for example, a family member of the user registered in the user ID a1.

Note that, although not illustrated in FIG. 8, the user data 100a further includes a password corresponding to the user of the user ID a1. In addition, the user data 100a includes a vehicle model name and a color of a vehicle corresponding to the registered vehicle number a3.

Furthermore, although not illustrated in FIG. 8, a face image of the user or an image of a family member having a family point ID may be registered as the user data 100a. In this way, by registering the face image of the user, the infrastructure server 20 (recognition server 20b) can perform matching processing between the face of the occupant of the vehicle 70 and the face image of the user registered in the user data 100a. As a result, it is possible to identify the occupant of the vehicle 70.

### Configuration of Parking Data

The configuration of the parking data 100b stored in the infrastructure server 20 (navigation server 20a) will be described with reference to FIG. 9. FIG. 9 is a diagram illustrating an example of a configuration of parking data stored in the infrastructure server according to the embodiment.

The parking data 100b includes current time b1, a parking area b2, a user ID b3, a vehicle number b4, a vehicle model b5, a color b6, a vehicle state b7, a vehicle position b8, a camera ID b9, an entrance b10, a parking position b11, an exit b12, a parking start time b13, a parking end time b14, and a parking position distance b15.

The current time b1 is a current time tracked by the infrastructure server 20.

The parking area b2 indicates a section in the parking lot 13.

The user ID b3 is identification information that is managed by the infrastructure server 20 and uniquely specifies a user who uses the parking lot 13.

The vehicle number b4 is information described on the license plate of the vehicle 70.

The vehicle model b5 is a vehicle name of the vehicle 70.

The color b6 is a color of the vehicle 70.

The vehicle state b7 indicates a state of the vehicle 70 inside the parking lot 13. In the vehicle state b7, for example, “traveling”, “parked”, and the like are stored. The vehicle state b7 is information based on a result of analyzing the image from the infrastructure camera 21 by the infrastructure server 20, and is updated as needed.

The vehicle position b8 indicates the position of the vehicle 70 inside the parking lot 13. In the vehicle position b8, coordinate values that can specify the position inside the parking lot 13 are stored. The vehicle position b8 is information based on a result of analyzing the image from the infrastructure camera 21 by the infrastructure server 20, and is updated as needed.

The camera ID b9 is information for specifying the infrastructure camera 21 currently imaging the vehicle 70.

The entrance b10 is information for specifying an entrance gate through which the vehicle 70 has passed when entering the parking lot 13. The entrance b10 is specified by the installation position of the entrance camera 22 that captures the image of the vehicle 70.

The parking position b11 is, for example, a parking frame number indicating the position of the parking frame in which the vehicle 70 is parked. When the vehicle state b7 is “parked”, the coordinate value indicated by the vehicle position b8 and the parking frame number indicated by the parking position b11 indicate the same position.

The exit b12 is information for specifying an exit gate through which the vehicle 70 has passed when exiting the parking lot 13. The exit b12 is specified by the installation position of the exit camera 23 that captures the image of the vehicle 70. Note that the information of the exit b12 is not used in the present embodiment.

The parking start time b13 is a time when the vehicle 70 enters the parking lot 13. Specifically, the parking start time is a time at which the entrance camera 22 images the license plate of the vehicle 70. Note that the parking start time b13 may be a time at which the infrastructure server 20 (recognition server 20b) determines that the vehicle 70 has completed parking based on the image acquired from the infrastructure camera 21.

The parking end time b14 is a time when the vehicle 70 exits from the parking lot 13. Specifically, the parking end time is a time at which the exit camera 23 images the license plate of the vehicle 70. Note that the parking end time b14 may be a time at which the infrastructure server 20 (recognition server 20b) determines that the vehicle 70 has started moving from the parking position based on the image acquired from the infrastructure camera 21.

The parking position distance b15 is a distance from the parking position of the vehicle 70 to the closest entrance connecting the parking lot 13 and the commercial facility 15, calculated by the infrastructure server 20 (recognition server 20b).

### Configuration of Map Data

The configuration of the map data 100c stored in the infrastructure server 20 (navigation server 20a) will be described with reference to FIG. 10. FIG. 10 is a diagram illustrating an example of a configuration of map data stored in the infrastructure server according to the embodiment.

The map data 100c includes a commercial facility name c1, parking lot map data c2, commercial facility map data c3, and camera position data c4.

The commercial facility name c1 is data indicating the name of the commercial facility 15. The commercial facility name c1 may include not only the name of the commercial facility 15 but also the name of a tenant in the commercial facility 15.

The parking lot map data c2 is map data indicating the position of the parking frame of the parking lot 13 and the parking frame number assigned to each parking frame.

The commercial facility map data c3 is map data indicating the arrangement of stores, the position of doorways, and the like of the commercial facility 15.

The camera position data c4 is map data indicating positions where the infrastructure camera 21, the entrance camera 22, and the exit camera 23 are arranged.

Note that these pieces of data included in the map data 100c do not need to be actual map data, and may be index information indicating a storage destination of the actual map data.

### Configuration of User Data

The configuration of the user data 100e stored in the store server 30 (point server 30b) will be described with reference to FIG. 11. FIG. 11 is a diagram illustrating an example of a configuration of user data stored in the store server according to the embodiment.

The user data 100e includes a facility e1, a point ID e2, a name e3, an address e4, a telephone number e5, an e-mail address e6, an age e7, a sex e8, a remaining point number e9, a family point ID e10, and a use store and frequency e11.

The facility e1 is identification information that uniquely specifies the commercial facility 15.

The point ID e2 is identification information that is managed by the store server 30 and uniquely specifies the user.

The name e3 is the name of the user corresponding to the point ID e2.

The address e4 is the address of the user corresponding to the point ID e2.

The telephone number e5 is a telephone number of the user corresponding to the point ID e2.

The e-mail address e6 is an e-mail address of the operation terminal 60 possessed by the user corresponding to the point ID e2.

The age e7 is the age of the user corresponding to the point ID e2.

The sex e8 is the sex of the user corresponding to the point ID e2.

The remaining point number e9 is the current number of points granted to the user corresponding to the point ID e2.

The family point ID e10 is a point ID of a user associated with the user corresponding to the point ID e2.

The use store and frequency e11 is identification information for uniquely specifying a store used in the facility e1 by the user corresponding to the point ID e2 and information indicating the use frequency of the store. Note that the use store and frequency e11 may store the store information and the frequency information of the store separately.

### Configuration of Point Data

The configuration of the point data 100f stored in the store server 30 (point server 30b) will be described with reference to FIG. 12. FIG. 12 is a diagram illustrating an example of a configuration of point data stored in the store server according to the embodiment.

The point data 100f includes a point ID f1, a purchase store f2, a purchase date and time f3, a purchase product f4, a price f5, a quantity f6, a discount rate f7, and a point number f8.

The point ID f1 is identification information that is managed by the store server 30 and uniquely specifies the user.

The purchase store f2 is identification information that uniquely specifies a store where an item is purchased in the commercial facility 15.

The purchase date and time f3 is information indicating the date and time of purchase of the purchase product f4.

The purchase product f4 is, for example, information indicating a product code that uniquely specifies a product purchased at the purchase store f2.

The price f5 is information indicating the price of the purchase product f4.

The quantity f6 is information indicating the quantity of purchase products f4.

The discount rate f7 is information indicating a discount rate of the price f5 of the purchase product f4 from the regular price.

The point number f8 is information indicating the number of points granted to the user corresponding to the point ID f1 by purchasing the purchase product f4.

### Configuration of POS Data

A configuration of POS data 100g stored in the store server 30 (POS server 30c) will be described with reference to FIG. 13. FIG. 13 is a diagram illustrating an example of a configuration of POS data stored in the store server according to the embodiment.

The POS data 100g includes a store g1, recommendation information and coupon information g2, a point ID g3, a purchase date and time g4, a purchase product g5, a price g6, a quantity g7, and a discount rate g8.

The store g1 is identification information that uniquely specifies a store in the commercial facility 15.

The recommendation information and coupon information g2 is recommendation information and coupon information related to the store g1.

The point ID g3 is identification information that is managed by the store server 30 and uniquely specifies the user.

The purchase date and time g4 is information indicating the date and time of purchase of the purchase product g5.

The purchase product g5 is, for example, information indicating a product code that uniquely specifies a product purchased at the store g1.

The price g6 is information indicating the price of the purchase product g5.

The quantity g7 is information indicating the quantity of purchase products g5.

The discount rate g8 is information indicating a discount rate of the price g6 of the purchase product g5 from the regular price.

### Configuration of Similar Store Data

The configuration of the similar store data 100h stored in the store server 30 (similar store server 30a) will be described with reference to FIG. 14. FIG. 14 is a diagram illustrating an example of a configuration of similar store data stored in the store server according to the embodiment.

The similar store data 100h includes a facility h1, a store h2, and a similar store h3.

The facility h1 is identification information that uniquely specifies the commercial facility 15.

The store h2 is identification information that uniquely specifies a store in the commercial facility 15.

The similar store h3 is identification information that uniquely specifies a store in the commercial facility 15 that sells a product similar to that sold in the store h2, that is, a product having the same product category as that of the store h2. Note that the product category is information such as male clothes, female clothes, child clothes, household products, and the like.

### Flow of Processing Performed by Parking Information-Linked Recommendation System

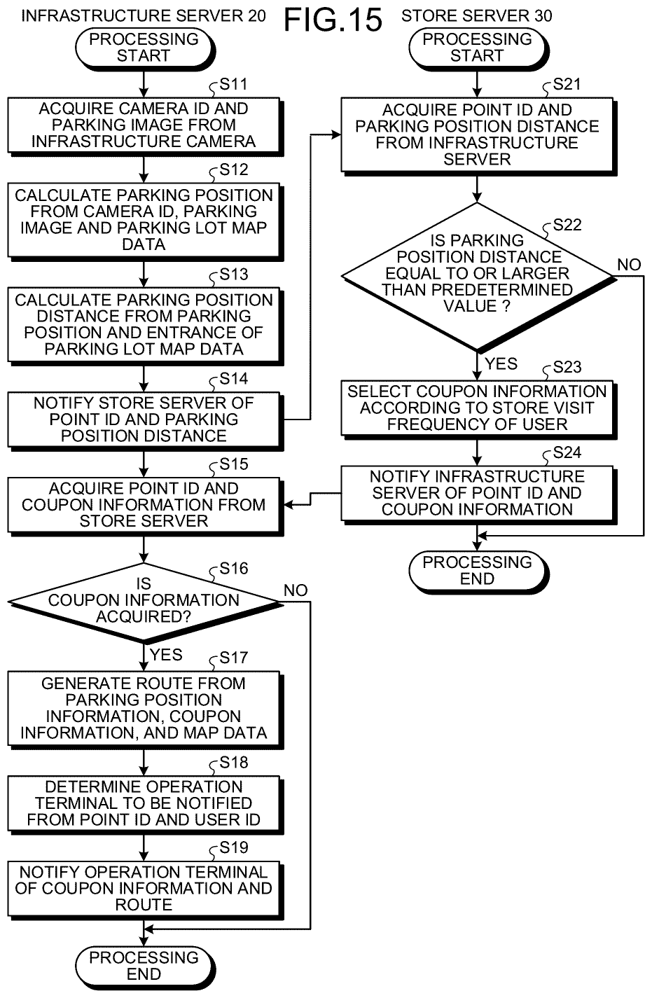

A flow of processing executed by the parking information-linked recommendation system 10 will be described with reference to FIG. 15. FIG. 15 is a flowchart illustrating an example of a flow of processing executed by the parking information-linked recommendation system according to the embodiment.

### Flow of Processing Performed by Infrastructure Server

The acquisition unit 52 of the infrastructure server 20 (recognition server 20b) acquires an image (this image is an image during parking, and is hereinafter referred to as a parking image) including the vehicle 70 that has passed through the entrance gate and the camera ID of the infrastructure camera 21 that has captured the image from among the images captured by the plurality of infrastructure cameras 21 (step S11).

The data processing unit 54 of the infrastructure server 20 (recognition server 20b) calculates the parking position from the camera ID and the parking image acquired in step S11 and the parking lot map data c2 stored in the navigation server 20a (step S12).

The data processing unit 54 of the infrastructure server 20 (navigation server 20a) calculates a parking position distance from the parking position of the vehicle 70 calculated in step S12 and the position of the doorway of the commercial facility map data cd stored in the navigation server 20a (step S13).

The output unit 56 of the infrastructure server 20 (WEB server 20d) notifies the store server 30 of the point ID and the parking position distance of the user associated with the vehicle 70 (step S14).

The acquisition unit 52 of the infrastructure server 20 (WEB server 20d) acquires the point ID and the coupon information from the store server 30 (step S15). Note that the coupon information can be acquired only when the parking position distance is equal to or larger than a predetermined value as described later.

The acquisition unit 52 of the infrastructure server 20 (WEB server 20d) determines whether the coupon information has been acquired in step S15 (step S16). When it is determined that the coupon information has been acquired (Step S16: Yes), the process proceeds to step S17. On the other hand, when it is not determined that the coupon information has been acquired (step S16: No), the infrastructure server 20 ends the processing of FIG. 15.

When it is determined in step S16 that the coupon information has been acquired, the data processing unit 54 of the infrastructure server 20 (navigation server 20a) creates route information from the parking position of the vehicle 70 to the store related to the coupon information via the closest entrance connecting the parking lot 13 and the commercial facility 15 based on the commercial facility map data cd stored in the navigation server 20a and the store related to the coupon information (step S17).

The data processing unit 54 of the infrastructure server 20 (account server 20c) determines the operation terminal 60 to be notified of the coupon information and the route information based on the point ID or the user ID associated with the point ID (step S18).

The output unit 56 of the infrastructure server 20 (WEB server 20d) notifies the operation terminal 60 determined in step S18 of the coupon information and the route information (step S19). Thereafter, the infrastructure server 20 ends the process of FIG. 15.

Even when the coupon information is not acquired from the store server 30, the infrastructure server 20 may generate route information from the parking position of the vehicle 70 to the closest entrance connecting the parking lot 13 and the commercial facility 15 and notify the operation terminal 60 of the route information.

### Flow of Processing Performed by Store Server

The acquisition unit 52 of the store server 30 (WEB server 30d) acquires the point ID and the parking position distance of the user associated with the vehicle 70 from the infrastructure server 20 (WEB server 20d) (step S21).

The data processing unit 54 of the store server 30 (point server 30b) determines whether the parking position distance acquired in step S21 is equal to or larger than a predetermined value (step S22). When it is determined that the parking position distance is equal to or larger than the predetermined value (step S22: Yes), the process proceeds to step S23. On the other hand, when it is not determined that the parking position distance is equal to or larger than the predetermined value (Step S22: No), the store server 30 ends the process of FIG. 15.

When it is determined in step S22 that the parking position distance is equal to or larger than the predetermined value, the data processing unit 54 of the store server 30 (point server 30b) selects the coupon information corresponding to the frequency of visit of the user based on the use store and frequency e11 of the user data 100e and the content of the POS data 100g (step S23).

The output unit 56 of the store server 30 (WEB server 30d) notifies the infrastructure server 20 of the coupon information selected in step S23 and the point ID (step S24). Thereafter, the store server 30 ends the process of FIG. 15.

### Example of User Information Registration Screen

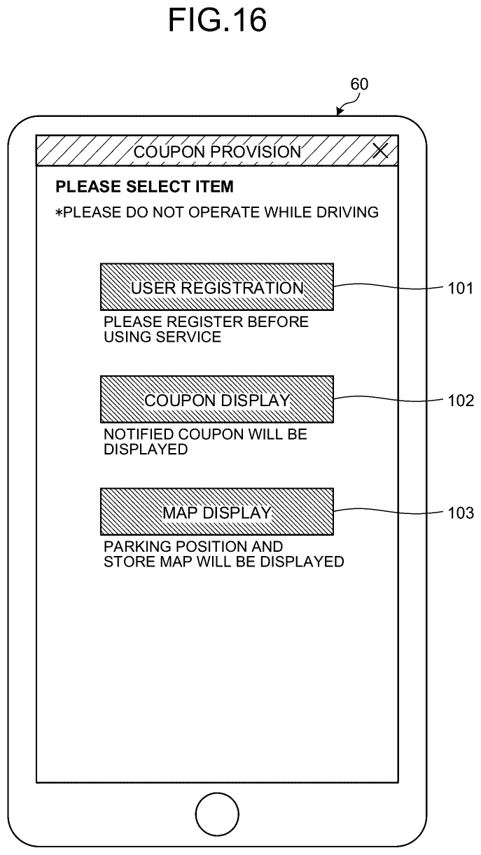

An example of a registration screen when the user who uses the parking information-linked recommendation system 10 registers user data using the operation terminal 60 will be described with reference to FIGS. 16 to 19. FIG. 16 is a diagram illustrating an example of a main menu screen displayed on the operation terminal.

FIG. 16 is an example of a main menu screen of an application of the parking information-linked recommendation system 10 displayed on the operation terminal 60 of the user. On the main menu screen, operation buttons indicating entrances to respective menus of a user registration button 101, a coupon display button 102, and a map display button 103 are displayed.

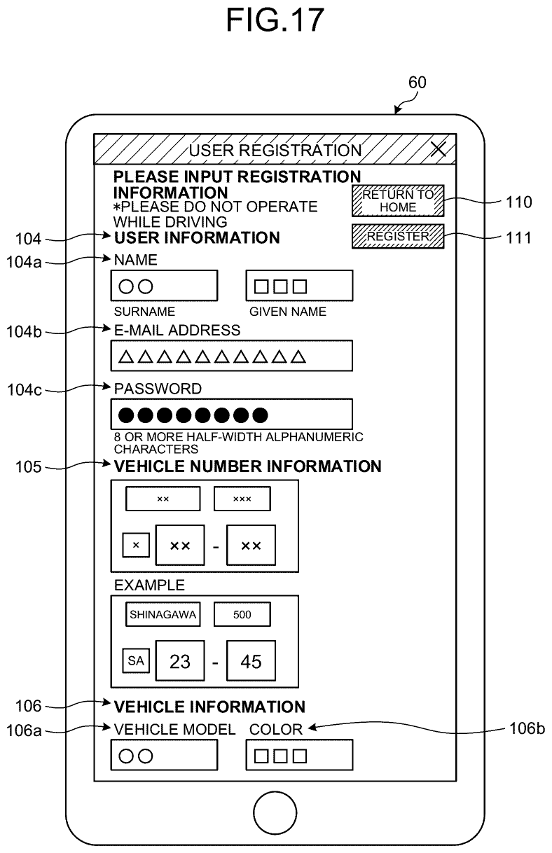

The user registration button 101 is a button pressed by the user when the user registers the user information and the vehicle information such as the vehicle number. When the user registration button 101 is pressed, for example, the screen transitions to a user registration screen illustrated in FIG. 17.

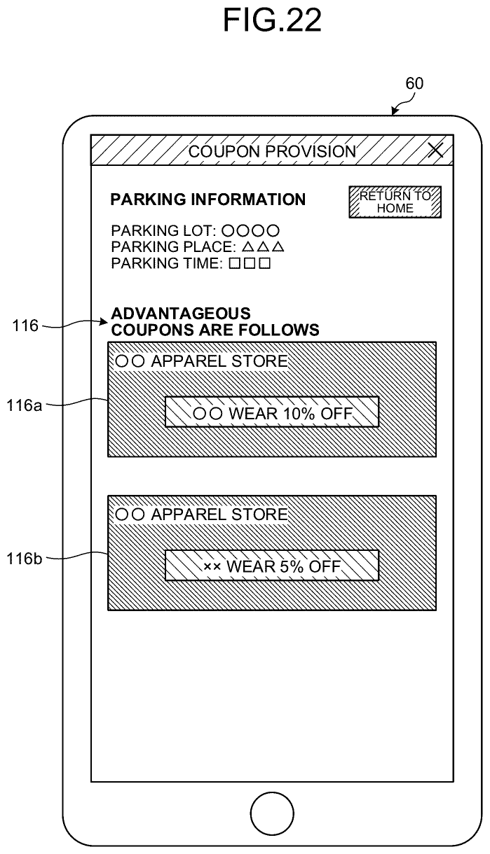

The coupon display button 102 is a button pressed when the coupon information delivered to the operation terminal 60 of the user is browsed. When the coupon display button 102 is pressed, for example, the screen transitions to a coupon information display screen illustrated in FIG. 22.

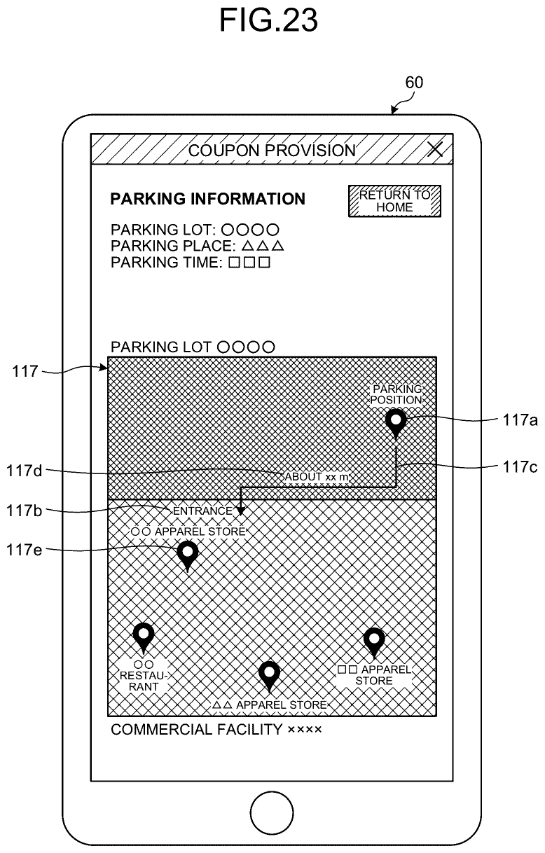

The map display button 103 is a button pressed when a map including a route from the parking position of the vehicle 70 to the closest entrance connecting the parking lot 13 and the commercial facility 15 is displayed. When the map display button 103 is pressed, for example, the screen transitions to a route display screen illustrated in FIG. 23.

FIG. 17 is a diagram illustrating an example of a user registration screen displayed on the operation terminal. The user registration screen is displayed when the user registration button 101 is pressed on the main menu screen. On the user registration screen, a return-to-home button 110, a registration button 111, a user information input field 104, a vehicle number information input field 105, and a vehicle information input field 106 are displayed. Note that FIG. 17 illustrates a state in which information is input in each input field, but when the screen has transitioned to the user registration screen, all the input fields are blank.

The return-to-home button 110 is, for example, a button pressed when transition to the main menu screen illustrated in FIG. 16 is desired.

The registration button 111 is a button pressed when the content input on the user registration screen is registered.

The user information input field 104 includes a name input field 104a, an e-mail address input field 104b, and a password input field 104c.

The name input field 104a is a field for inputting the first and last name of the user.

The e-mail address input field 104b is a field for inputting the e-mail address of the user.

The password input field 104c is a field for inputting the password of the user.

The vehicle number information input field 105 is a field for inputting the content of the license plate of the vehicle 70 used by the user.

The vehicle information input field 106 includes a vehicle model input field 106a and a color input field 106b.

The vehicle model input field 106a is a field for inputting a vehicle model name of the vehicle 70.

The color input field 106b is a field for inputting the color of the vehicle 70.

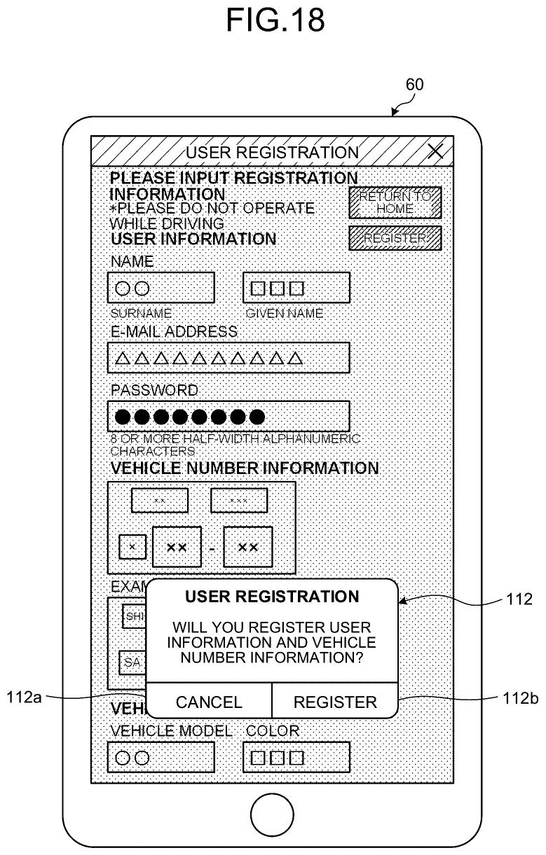

FIG. 18 is a diagram illustrating an example of a screen displayed when the input user information is registered in the infrastructure server. That is, FIG. 18 is an example of a screen displayed when the registration button 111 of FIG. 17 is pressed after necessary information is input on the user registration screen of FIG. 17.

When the registration button 111 in FIG. 17 is pressed, a user registration execution confirmation window 112 is displayed on the operation terminal 60 so as to be superimposed on the hatched user registration screen as illustrated in FIG. 18. The user registration execution confirmation window 112 includes a cancellation button 112a and a registration button 112b.

The cancellation button 112a is a button for canceling execution of user registration. When the cancellation button 112a is pressed, the screen transitions to the user registration screen in FIG. 17.

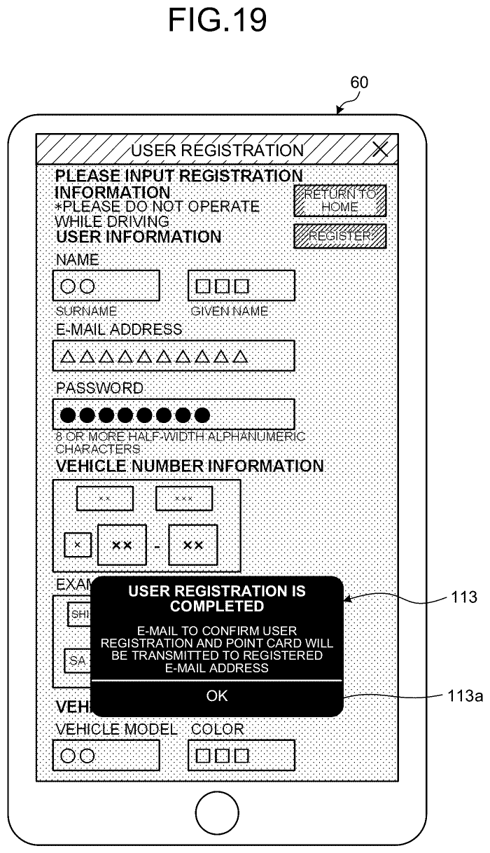

The registration button 112b is a button for instructing execution of user registration. When the registration button 112b is pressed, the information input on the user registration screen is registered in the infrastructure server 20 (account server 20c). Then, the screen of the operation terminal 60 transitions to a screen of FIG. 19 to be described later.

FIG. 19 is a diagram illustrating an example of a feedback screen indicating that user information has been registered. On the feedback screen, a registration confirmation window 113 is displayed so as to be superimposed on the hatched user registration screen. The registration confirmation window 113 is a message window notifying that the user information and the information of the point card are transmitted to the registered e-mail address. The registration confirmation window 113 includes a confirmation button 113a.

The confirmation button 113a is a button for permitting transmission of the user information and the information of the point card to the operation terminal 60. When the user of the operation terminal 60 presses the confirmation button 113a, the infrastructure server 20 transmits an e-mail including the registered user information and the information of the point card to the registered e-mail address, that is, the operation terminal 60 for which the registration operation has been performed. The user confirms that the registration of the user information is completed by confirming the user information and the information of the point card described in the received e-mail.

### Display Screen Example of Coupon Information

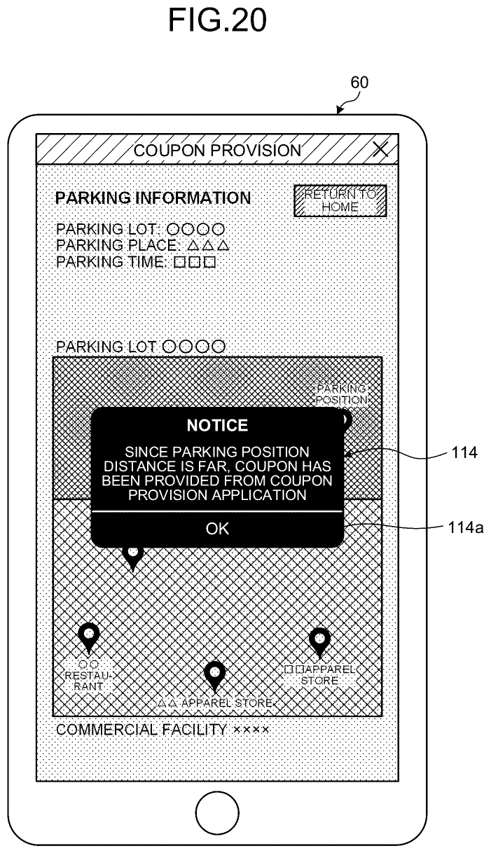

An example of a screen displayed when the parking information-linked recommendation system 10 notifies the operation terminal 60 of the user of coupon information will be described with reference to FIGS. 20 to 22. FIG. 20 is a diagram illustrating an example of a coupon information notification screen displayed on the operation terminal. That is, when the operation terminal 60 receives the coupon information from the infrastructure server 20, a coupon information notification window 114 is displayed so as to be superimposed on the screen of the operation terminal 60.

The coupon information notification window 114 is a message window for notifying that coupon information is to be notified because the parking position distance from the parking position of the vehicle 70 to the closest entrance connecting the parking lot 13 and the commercial facility 15 is equal to or larger than a predetermined value. The coupon information notification window 114 includes a confirmation button 114a.

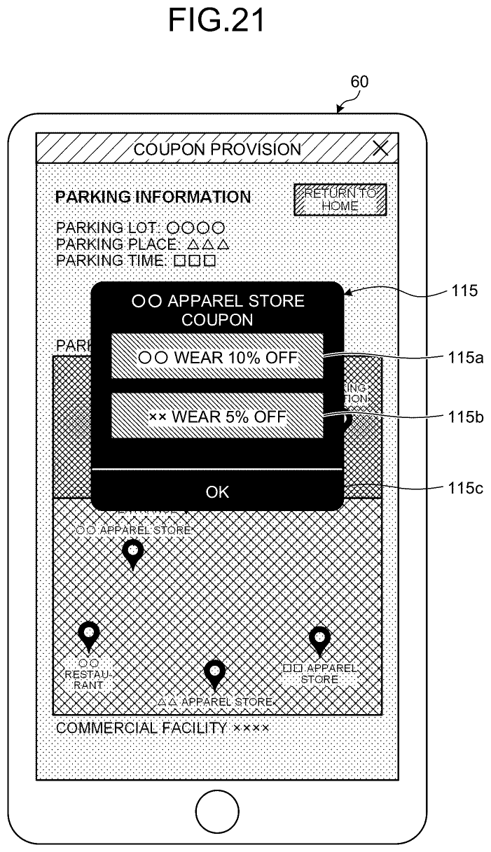

The confirmation button 114a is a button for permitting the notification of the coupon information. When the confirmation button 114a is pressed, the screen transitions to a screen of FIG. 21 to be described later.

FIG. 21 is a diagram illustrating an example of a coupon information summary display screen displayed on the operation terminal. The coupon information summary display screen illustrated in FIG. 21 is displayed when the confirmation button 114a in FIG. 20 is pressed.

The coupon information summary display screen includes a coupon summary display window 115 superimposed on the screen of the operation terminal 60. The coupon summary display window 115 includes coupon information 115a, coupon information 115b, and a confirmation button 115c. Note that FIG. 21 illustrates an example in which a plurality of pieces of coupon information is notified from the same store. Thus, the number of pieces of coupon information notified from the same store is not limited.

The coupon information 115a is coupon information representing a coupon available at one store displayed at the top of the coupon summary display window 115.

The coupon information 115b is coupon information representing a coupon available at one store displayed at the top of the coupon summary display window 115.

The confirmation button 115c is a button for permitting detailed display of the coupon information. When the confirmation button 115c is pressed, the screen transitions to a screen of FIG. 22 to be described later.

Although not illustrated, the parking information-linked recommendation system 10 may make notification of coupon information of a plurality of stores. That is, as described above, the coupon information available in a second store different from the one store among the plurality of stores where the use frequency by the user is equal to or larger than a certain value may be notified together. In this case, the coupon summary display window 115 displays the coupon information for each store by dividing the window, for example.

FIG. 22 is a diagram illustrating an example of a coupon information detail display screen displayed on the operation terminal. The coupon information detail display screen illustrated in FIG. 22 is displayed when the confirmation button 115c in FIG. 21 is pressed. The coupon information detail display screen illustrated in FIG. 22 is also displayed when the coupon display button 102 in FIG. 16 is pressed.

The coupon information detail display screen includes a coupon information display field 116 and coupon detailed information 116a and 116b.

The coupon information display field 116 displays the notified coupon information for each store. FIG. 22 illustrates an example of a case where two types of coupon information are notified from the same store.

The coupon detailed information 116a and 116b indicate detailed contents of the coupon information for each piece of the notified coupon information. Note that a portion indicating a discount target product displayed in each of the coupon detailed information 116a and 116b may be used as an operation button, and an image and detailed description of the corresponding product may be displayed by pressing the operation button. Note that the user can use the notified coupon information by presenting the coupon information detail display screen of FIG. 22 in the corresponding store.

### Route Display Screen Example

An example of a screen displayed when the parking information-linked recommendation system 10 notifies the operation terminal 60 of the user of coupon information will be described with reference to FIG. 23. FIG. 23 is a diagram illustrating an example of a route display screen displayed on the operation terminal. The route display screen illustrated in FIG. 23 is displayed when the map display button 103 in FIG. 16 is pressed.

The route display screen includes a map 117. The map 117 includes a walking route 117c from the parking position 117a in the parking lot 13 to the entrance 117b connecting the parking lot 13 and the commercial facility 15, and the parking position distance information 117d. In addition, the map 117 indicates the position of the store 117e that has made notification of the coupon information and the position of a store that the user has visited at a high frequency other than the store 117e in the commercial facility 15.

### Operation Effect of Present Embodiment

As described above, the information providing method in the parking information-linked recommendation system 10 according to the present embodiment is an information providing method in the sales information management system 14 including the store server 30 (second server) that communicates with the parking management system 12 including the infrastructure server 20 (first server) related to the parking lot 13 and stores purchase information of the user in the commercial facility 15 in association with the point ID of the user in connection with the commercial facility 15, the information providing method including: acquiring, from the infrastructure server 20, the point ID corresponding to the user who is on the vehicle 70 parked in the parking lot 13 and the parking position distance information indicating the distance from the parking position where the vehicle 70 is parked in the parking lot 13 to the entrance connecting the parking lot 13 and the commercial facility 15, in which, in the parking management system 12, the vehicle number indicating the vehicle 70 and the parking position distance information are determined using the vehicle image indicating the vehicle 70 acquired by the infrastructure camera 21 (camera) installed in the parking lot 13, and the corresponding point ID is determined based on the vehicle number; and when the distance from the parking position to the entrance connecting the commercial facility 15 and the parking lot 13 is equal to or larger than a predetermined value based on the purchase information of the user corresponding to the point ID and the parking position distance information, transmitting first coupon information representing a coupon available in at least one store among a plurality of stores where a use frequency by the user is equal to or larger than a certain value to the infrastructure server 20 in order to display the first coupon information on the operation terminal 60 (information terminal) of the user corresponding to the point ID. Therefore, it is possible to give an incentive according to a parking position to a user. Further, as a result, since it is possible to prevent the vehicle 70 from staying near the entrance connecting the parking lot 13 and the commercial facility 15, it is possible to reduce uneven congestion of the parking lot 13.

In the information providing method in the parking information-linked recommendation system 10 according to the present embodiment, the parking management system 12 stores the point ID of the user in association with the vehicle number of the user. Therefore, when it is detected that the user has entered the parking lot 13, it can be recognized that the user has visited the commercial facility 15.

In the information providing method in the parking information-linked recommendation system 10 according to the present embodiment, the first coupon information is transmitted from the infrastructure server 20 (first server) to the operation terminal 60 of the user. Therefore, since the store server 30 does not need to have a communication function with the operation terminal 60, the system configuration can be simplified.

In the information providing method in the parking information-linked recommendation system 10 according to the present embodiment, when the first coupon information is transmitted, map information representing a route from the parking position to one store via an entrance connecting the commercial facility 15 and the parking lot 13 is transmitted from the infrastructure server 20 (first server) to the operation terminal 60 of the user. Therefore, since the store server 30 does not need to have a communication function with the operation terminal 60, the system configuration can be simplified.

Further, in the information providing method in the parking information-linked recommendation system 10 according to the present embodiment, the user includes a driver of the vehicle 70. Therefore, by specifying the vehicle 70 that has entered the parking lot 13, the user associated with the vehicle 70 in advance can be specified.

In addition, in the information providing method in the parking information-linked recommendation system 10 according to the present embodiment, the user includes a fellow passenger of the vehicle 70 managed as a family member of the driver of the vehicle 70. Therefore, by specifying the vehicle 70 that has entered the parking lot 13, a family, a friend, or the like associated with the user of the vehicle 70 in advance can be specified.

Further, in the information providing method in the parking information-linked recommendation system 10 according to the present embodiment, when second coupon information representing a coupon available in a second store different from one store among a plurality of stores where a use frequency by the user is equal to or larger than a certain value is transmitted and one of the first coupon information and the second coupon information is used, the other one of the first coupon information and the second coupon information is invalidated in the sales information management system 14. Therefore, by expanding the range of available stores of the coupon information, the coupon information that can actually be used by the user is provided, and the available coupon information is limited to any one piece of coupon information, and thus, it is possible to adjust an incentive corresponding to the degree of inconvenience of the user for using the parking position far from the entrance while giving an incentive to the user who uses the parking position far from the entrance of the commercial facility.

Further, the parking information-linked recommendation system 10 (information providing system) according to the present embodiment includes the store server 30 (second server) that communicates with the parking management system 12 including the infrastructure server 20 (first server) related to the parking lot 13 and stores purchase information of the user in the commercial facility 15 in association with the point ID of the user in connection with the commercial facility; acquires, from the infrastructure server 20, the point ID corresponding to the user who is on the vehicle 70 parked in the parking lot 13 and the parking position distance information indicating the distance from the parking position where the vehicle 70 is parked in the parking lot 13 to the entrance connecting the parking lot 13 and the commercial facility 15, in the parking management system 12, the vehicle number indicating the vehicle 70 and the parking position distance information being determined using the vehicle image indicating the vehicle 70 acquired by the infrastructure camera 21 installed in the parking lot 13, and the corresponding point ID being determined based on the vehicle number; and when the distance from the parking position to the entrance connecting the commercial facility 15 and the parking lot 13 is equal to or larger than a predetermined value based on the purchase information of the user corresponding to the point ID and the parking position distance information, transmits first coupon information representing a coupon available in at least one store among a plurality of stores where a use frequency by the user is equal to or larger than a certain value to the infrastructure server 20 in order to display the first coupon information on the operation terminal 60 of the user corresponding to the point ID. Therefore, it is possible to give an incentive according to a parking position to a user. Further, as a result, since it is possible to prevent the vehicle 70 from staying near the entrance connecting the parking lot 13 and the commercial facility 15, it is possible to reduce uneven congestion of the parking lot 13.

According to the information providing method according to the present disclosure, it is possible to give an incentive according to a parking position to a user.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information providing method in a sales information management system including a second server that communicates with a parking management system including a first server related to a parking lot and stores purchase information of a user in a commercial facility in association with a point ID of the user in connection with the commercial facility, the information providing method comprising:
acquiring, from the first server, the point ID corresponding to the user who is on a vehicle parked in the parking lot and parking position distance information indicating a distance from a parking position where the vehicle is parked in the parking lot to an entrance connecting the parking lot and the commercial facility, wherein a vehicle number indicating the vehicle and the parking position distance information are determined using a vehicle image indicating the vehicle acquired by a camera installed in the parking lot, and the corresponding point ID is determined based on the vehicle number, in the parking management system; and
when the distance from the parking position to the entrance connecting the commercial facility and the parking lot is equal to or larger than a predetermined value based on the purchase information and the parking position distance information of the user corresponding to the point ID, transmitting, to the first server, first coupon information representing a coupon available in at least one store among a plurality of stores where a use frequency by the user is equal to or larger than a certain value in order to display the first coupon information on an information terminal of the user corresponding to the point ID.

2. The information providing method according to claim 1, wherein
the point ID is stored in association with the vehicle number in the parking management system.

3. The information providing method according to claim 1, wherein
the first coupon information is transmitted from the first server to the information terminal.

4. The information providing method according to claim 3, wherein
map information indicating a route from the parking position to the at least one store via the entrance is transmitted from the first server to the information terminal when the first coupon information is transmitted.

5. The information providing method according to claim 1, wherein
the user includes a driver of the vehicle.

6. The information providing method according to claim 5, wherein
the user includes a fellow passenger of the vehicle managed as a family member of the driver of the vehicle.

7. The information providing method according to claim 1, wherein
second coupon information representing a coupon available in a second store different from the at least one store among the plurality of stores where the use frequency by the user is equal to or larger than the certain value is transmitted, and
when either one of the first coupon information and the second coupon information is used, another one of the first coupon information and the second coupon information is invalidated in the sales information management system.

8. An information providing system comprising a second server that communicates with a parking management system including a first server related to a parking lot and stores purchase information of a user in a commercial facility in association with a point ID of the user in connection with the commercial facility, the information providing system being configured to:
acquire, from the first server, the point ID corresponding to the user who is on a vehicle parked in the parking lot and parking position distance information indicating a distance from a parking position where the vehicle is parked in the parking lot to an entrance connecting the parking lot and the commercial facility, wherein a vehicle number indicating the vehicle and the parking position distance information are determined using a vehicle image indicating the vehicle acquired by a camera installed in the parking lot, and the corresponding point ID is determined based on the vehicle number, in the parking management system, and
when the distance from the parking position to the entrance connecting the commercial facility and the parking lot is equal to or larger than a predetermined value based on the purchase information and the parking position distance information of the user corresponding to the point ID, transmit, to the first server, first coupon information representing a coupon available in at least one store among a plurality of stores where a use frequency by the user is equal to or larger than a certain value in order to display the first coupon information on an information terminal of the user corresponding to the point ID.
